(19) United States
(12) Patent Application Publication
(10) Pub. No.: US 2007/0194649 A1
(43) Pub. Date: Aug. 23, 2007

(54) Electric camshaft adjuster comprising a pancake motor

(75) Inventors: Jens Schäfer, Herzogenaurach (DE); Martin Steigerwald, Erlangen (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 10/599,122

(22) PCT Filed: Feb. 16, 2005
(86) PCT No.: PCT/EP05/01551

§ 371 Date: Sep. 20, 2006

(30) Foreign Application Priority Data
Mar. 26, 2004 (DE) 10 2004 014 865.1

(51) Int. Cl. H02K 7/10; H02K 21/12; H02K 1/22

(52) U.S. Cl. 310/156.32; 310/268; 310/83; 310/156.37; 310/75 R

(57) ABSTRACT

An electric camshaft adjuster for adjusting and fixing the phase angle of a camshaft of an internal combustion engine relative to a crankshaft thereof is provided. The camshaft adjuster is provided with a triple-shaft gear drive having a driving pinion that is fixed to the crankshaft, an output part which is fixed to the camshaft, and an adjusting shaft. The adjusting shaft is connected to a motor shaft (5, 5′, 5″) of an electric adjusting motor that is provided as a pancake motor (1, 1′, 1″, 1′″) including a pancake (3, 3′, 3″) and a stator (15, 15′, 15″, 15′″) which is disposed in a housing (8, 8′, 8″) with an associated cover (9, 9′, 9″). In order to create a camshaft adjuster that is inexpensive to produce and operate, the pancake motor (1, 1′, 1″, 1′″) is configured as a brushless DC motor (BLDC motor) whose housing (8, 8′, 8″) and cover (9, 9′, 9″) are arranged to be fixed to the cylinder head and whose motor shaft (5, 5′, 5″) is connected to the adjusting shaft by a releasable coupling.

### FIELD OF THE INVENTION

The invention relates to an electric camshaft adjuster for adjusting and fixing the phase angle of a camshaft of an internal combustion engine relative to the crankshaft thereof. The camshaft adjuster is provided with a triple-shaft gear drive and an adjusting motor embodied as a pancake motor, especially according to the preamble of claim 1.

### BACKGROUND OF THE INVENTION

Typical electric camshaft adjusting systems feature an adjusting gear drive and an adjusting motor, which is embodied as an internal rotor with a cylindrical rotor construction.

In modern vehicles, certain distances between the car body and internal combustion engine are required due to safety concerns (crash behavior). From that follows the desire for motors that are as compact as possible. This desire stands contrary to the need for installation space for the adjusting gear drive and adjusting motors, which are arranged axially one behind the other. This is especially problematic in vehicles with transversely mounted motors.

For this type of adjusting gear drive, the installation space of the camshaft adjuster can be decreased only by shortening the adjusting motor. However, this also reduces its torque. This depends on the electric force Fₑₗ generated in the air gap between the rotor and stator when the electric motor is powered and on the effective lever arm d_{R}/2, wherein d_{R} designates the diameter of the rotor. The lever arm d_{R}/2 can be increased only with difficulty by increasing the rotor diameter in an internal rotor with a cylindrical rotor construction with radial air gap and a relatively small rotor diameter. All that remains for increasing the torque is to increase the electric force Fₑₗ. This can be achieved by increasing the magnetic flux density. The path to this result through the increase of current has the disadvantage of increasing the power losses and consequently the electric motor temperature. In addition, there is the risk of demagnetizing the permanent magnet rotor. Increasing the magnetic flux density of this rotor through a corresponding magnetic material is expensive.

A brushless DC motor with a pancake construction offers an interesting possibility for decreasing the installation length of the electric camshaft adjuster. This construction involves a disk-shaped armature (rotor), which is composed of magnetized circular sectors. The magnetic poles of a magnetized circular sector element point in the axial direction. Furthermore, the polarity of adjacent circular sectors alternate. Advantageously, the circular sectors are manufactured separately and then mounted on a carrier element, wherein the magnetized circular sectors are preferably composed of a magnetizable metal, a magnetizable metal alloy, or plastic, which is provided with magnetizable particles.

At least one stator, which is provided with winding parts, is allocated to the rotor. The rotor is driven by selectively energizing the winding parts with the correct current polarity. Position sensors detect the position of the rotor relative to the stator. Based on this information, the individual winding parts are fed a current of the correct polarity at the proper time. Available position sensors are, for example, Hall sensors or sensors, whose resistance is dependent on a magnetic field (magnetoresistive effect).

The pancake motors can be divided into categories of internal and external rotors.

In internal rotor motors, the rotor does not project over the stator or the stators. In a first embodiment of the motor, the stator has an essentially ring-shaped construction and surrounds the rotor in the radial direction, whereby an air gap is defined in the peripheral direction between the rotor and stator. In another embodiment, the stator also has a ring-shaped construction, but is arranged offset to the stator in the axial direction. In this way, a ring-shaped air gap is also defined, which is located between the rotor and stator in the axial direction. A magnetizable disk is advantageously arranged in the axial direction towards the rotor and on the side facing away from the stator for improved magnetic flux recovery.

Also possible is an arrangement, in which a ring-shaped stator is arranged in front of and behind the rotor in the axial direction. In this embodiment, two ring-shaped air gaps are defined, wherein each air gap lies between the rotor and one of the two stators in the axial direction. An external rotor is also possible, in which the outer disk rotor surrounds the inner stator. Due to the accumulation of mass at a large diameter, this solution has a high mass moment of inertia, which exerts a negative influence on its dynamics when accelerating and braking the pancake motor. Consequently, the internal rotor version with axial air gap is an advantageous variant of the pancake motor.

Because the diameter of the pancake and thus the lever arm of the electric force Fₑₗ can be selected considerably larger than that of a cylindrical rotor, the torque of the pancake motor is considerably above this value. Therefore, the higher mass moment of inertia of the pancake motor is also compensated for to a large extent, so that its dynamic response is barely affected. Consequently, with a smaller axial length, the pancake motor achieves at least an equal power output relative to that of the cylindrical rotor motor.

The pancake motor offers various possible constructions, which permit its adaptation to different applications.

For the concept or design of a pancake motor, among other things, the following structural elements are made available:
Number of air gaps (one or two)
Stator winding type (single pole or non-single pole)
Permanent magnet (sintered or plastic-bonded)
Stator core (slotted, i.e., winding with iron, or non-slotted, i.e., iron-free winding)
Rotor and stator yoke (stationary or rotating)
Conductor type (enameled wire or insulated laminations or molded parts)
Number of stator poles (low pole count, i.e., ≦ten poles, or high pole count, i.e., ≧ten poles).

In the following, the features of the two choices for the structural elements are listed:
One air gap:
   Stator winding is located on only one side of the permanent magnet rotor, whereby an axial force acts on the bearing.
Two air gaps:
   Here two arrangements are conceivable. First, a stator can be mounted in front of and behind the rotor in the axial direction. Also conceivable is a rotor that surrounds the stator in the axial direction.
Single pole:
   Coils are wound around stator teeth in a concentrated way, wherein one tooth is equal to one pole.
Non-single pole:
   Coils are wound around several stator teeth and overlap at the coil end that has greater dimensions.
Sintered magnets:
   High flux density of Br>0.8 tesla, expensive.
Plastic-bonded magnets:
   Flux density Br≦0.8 tesla, economical, variable, but sensitive to temperature.
Slotted stator core:
   Stator with teeth requires high manufacturing expense, but offers concentrated flux in the teeth and smaller air gap (distance) between rotor and stator.
Non-slotted stator core:
   With a laminated stack as a toroidal magnetic-strip wound core, on which an air-gap winding is placed, a large magnetic air gap with smaller flux concentration is created. However, in this embodiment the low manufacturing expense has an advantageous effect.
Stationary yoke:
   High magnetization losses that are reduced by bundling laminations. However, the low mass moment of inertia achieved in this way for the rotor is advantageous.
Rotating yoke:
   Offers low magnetization losses, because the solid yoke rotates with the permanent magnet rotor. However, this causes a high mass moment of inertia.
Enameled wire conductor:
   Permits conventional windings, which, however, require special winding machines.
Laminated conductor:
   The winding is built from stamped or etched sheets and requires insulation and assembly expense.
Low pole count for the pancake:
   Offers low stray flux but requires a thick yoke with corresponding installation space and mass moment of inertia.
High pole count:
   Causes high stray flux, but permits a thin yoke with small mass moment of inertia.

By combining the different structural elements, a plurality of various pancake variants is possible, of which many are not useful, but all can be realized.

In the following, a few structural elements and the matching supplemental structural elements are listed:
Non-slotted (iron-free) stator core requires:
Sintered magnets of the pancake due to larger magnetic gap.
A low pole count pancake due to magnetic field stray dispersion.
A high pole count pancake requires:
A slotted stator due to magnetic field stray dispersion.
A plastic-bonded magnet in a pancake requires:
A slotted stator due to small magnetic flux density.
A yoke rotating with the pancake requires:
A high pole count pancake due to the possible small yoke thickness (low mass moment of inertia).
An air gap requires:
A high pole count pancake due to the possible thin flux ring on the pancake (low mass moment of inertia).

Additional combinations of the structural elements are listed in the table of FIGS. 5 and 5a.

All of the slotted variants with two air gaps can have both symmetrical and also asymmetrical constructions.

For a symmetric construction, a coil with a yoke is arranged on both sides of the permanent magnet pancake, while for an asymmetric construction, the coil with a yoke is located on one side and only a yoke is located on the other side.

The coil with a yoke can be used with only one air gap even for a permanent magnet pancake.

In a comparison of the 44 variants in FIGS. 5 and 5a, the variant 1 appears to be especially advantageous for an embodiment with one air gap and the variant 22 appears to be especially advantageous for an embodiment with 2 air gaps:
The high pole count, iron-bonded winding of the stator is built very short axially;
The plastic-bonded magnet in the permanent magnet pancake can be produced economically;
The enameled wire used for the stator winding is economical;
The torque-generating portion of the stator winding is high due to the low winding head portion;
The mass moment of inertia of the pancake is low due to the stationary yoke.

However, all of the other variants, especially variant 36, come into play as pancake motors for electric camshaft adjusters. Because all of the variants have their specific advantages and disadvantages, the selection is determined by the appropriate application.

In EP 1 039 101 A2, an electric camshaft adjuster with an adjusting motor embodied as a pancake is disclosed.

This pancake motor forms a unit with the adjusting gear drive, so that it rotates with this gear drive. Therefore, power is supplied to the adjusting motor via slip rings. In this solution, the use of slip rings has a disadvantageous effect on the axial installation space. Furthermore, the use of slip rings is associated with wear and thus leads to a shorter motor service life.

It is further disadvantageous that the motor shaft is embodied in one piece with the adjusting shaft. This has the consequence that the adjusting motor must be assembled together with the adjusting gear drive and must be repaired in the assembled state in the case of a defect.

### OBJECT OF THE INVENTION

The invention is based on the objective of creating a pancake motor according to the class for an electric camshaft adjuster, whose production and operation are economical.

### SUMMARY OF THE INVENTION

The objective is met by the features of claim 1.

Therefore, because the pancake motor is embodied as a brushless DC motor (BLDC motor), brush losses are eliminated.

In addition, because the housing and the cover and thus also the stator are tight to the cylinder head, any slip rings and the associated problems are eliminated.

Because the shaft is connected to the adjusting shaft by a detachable coupling, the adjusting motor can be exchanged and mounted and repaired independent from the adjusting gear drive, as well as used for other purposes.

The detachable coupling can be constructed, for example, as a splined shaft, elastic rubber element, or magnetic coupling.

Therefore, the electrical installation of the adjusting motor is considerably simplified, because the cover or the housing is embodied as a sensor module composed of plastic, in which a punched lattice is integrated, which is used for guiding connection of a plug injection-molded on the cover with position sensors for the electronic commutation, as well as with connections for the stator.

The invention offers cost advantages if the position sensors can respond to the pancake. Alternatively, there is also the possibility of being able to trigger the magnet pulses by an additionally mounted sensor magnet.

In an advantageous refinement of the invention, the pancake is composed of a permanent magnet, which is sintered or bonded to plastic and which is mounted on a disk-shaped carrier, by means of which the pancake is pressed onto the motor shaft. The sintered pancake achieves higher flux densities and thus a higher torque than the plastic-bonded pancake, which is more economical in production and more variable in shaping, but is also more sensitive to temperature.

If the stator is slotted, a higher magnetic flux is generated in the stator teeth, while a higher stray flux is generated by a more economical toroidal magnetic-strip wound core of a non-slotted stator. Therefore, the torque and efficiency of the adjusting motor decreases.

Advantageous alternatives for the stator yoke include the stator yoke being embodied as a toroidal magnetic-strip wound core and the stator core embodied as a sintered disk with sintered teeth that are separate but can be joined together, or that the stator yoke and the stator core can be produced in one piece from a wide toroidal magnetic-strip wound core by milling or stamping the stator slots from this core. The joining can be realized, e.g., by screws or rivets, after the winding has been placed on the stator core.

It is also advantageous that an end stage of the pancake motor is preferably operated in a bipolar way.

An advantageous refinement of the invention includes the pancake being supported on rollers, and the roller bearing is preferably embodied as a deep groove ball bearing and preferably arranged in the housing and in the cover.

Alternatively, needle, roller, or sliding bearings are also conceivable. Likewise, it is possible to support the motor shaft with one roller bearing in the motor housing and with another roller bearing via the coupling in the gear drive housing.

Another possibility offers a floating bearing of the motor shaft in the motor housing.

The solution, in which the motor shaft can be supported on its inner ring for a deep groove ball bearing close to the output and on its outer ring for a deep groove ball bearing away from the output, requires particularly little axial installation space. In this way, the bearing away from the output is arranged at least partially in the pancake.

It is advantageous when preferably an O-ring is provided between the housing and cover as a seal and when preferably a radial shaft seal is provided between the motor shaft and housing.

The O-ring can also be replaced by a paper seal or a sealing paste. Instead of the radial shaft seal ring, a labyrinth seal or a sealed deep groove ball bearing can also be used.

Pancake motors can have one or two air gaps. Pancake motors with one air gap apply an axial force on the bearing, which is theoretically compensated, but in practice is at least reduced due to tolerances for two air gaps.

An advantageous refinement of the invention provides that for a pancake motor with one air gap, a coaxial motor shaft compression spring acting on the motor shaft in the direction of the stator and/or a coaxial stator compression spring acting on the stator in the direction of the pancake are provided.

The two compression springs are used for minimizing the air gap of the pancake by bridging the bearing play of the roller bearing and the installation play of the stator. Through the smallest possible air gap width, a maximum torque of the pancake motor is guaranteed.

Therefore, because for pancake motors with two air gaps, one component (rotor or stator) is moved by the other component (two-part stator or two-part rotor) into the middle in the axial direction, the axial forces on the motor shaft, apart from tolerances, increases.

This also applies to the case that two or more pancakes are each arranged with air gaps on a motor shaft one behind the other.

In one advantageous configuration of the invention, the winding parts of the stator consist of stamped sheets, molded parts, or enameled wire.

Furthermore, the number of pole pairs equals preferably 2 to 12.

### BRIEF DESCRIPTION OF THE DRAWING

Additional features of the invention result from the following description and the drawings, in which embodiments of the invention are shown schematically.

Shown are:

FIG. 1 a schematic representation of a camshaft adjuster with a triple-shaft gear drive and a drive motor;

FIG. 2 a brushless pancake motor with two air gaps and a two-part stator;

FIG. 3 a schematic of an alternative pancake motor with two air gaps and a two-part pancake;

FIG. 4 a brushless pancake motor with one air gap;

FIG. 5 a brushless pancake motor with one air gap and alternative bearing of the motor shaft;

FIG. 5a a brushless pancake motor with one air gap and a second alternative bearing of the motor shaft;

FIG. 5b a brushless pancake motor with one air gap and a third alternative bearing of the motor shaft;

FIGS. 6 and 6a tables with pancake motor variants;

FIG. 7a a brushless pancake motor with a first position sensor arrangement;

FIG. 7b an alternative embodiment of a brushless cylindrical rotor motor with a second position sensor arrangement;

### DETAILED DESCRIPTION OF THE DRAWINGS

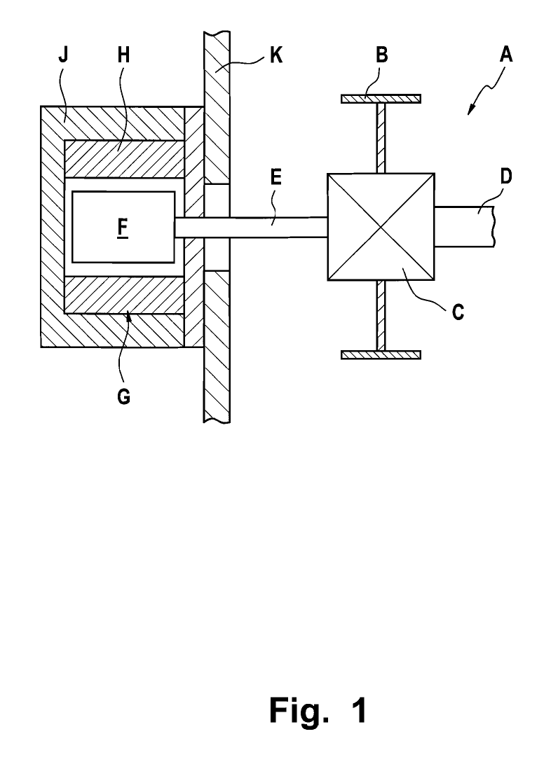

In FIG. 1, a schematic view of a camshaft adjuster A is shown, with a drive wheel B, which drives an adjusting gear drive C. The adjusting gear drive C, which is advantageously embodied as a triple-shaft gear drive, is connected to the camshaft D and a motor shaft E. The motor shaft E is driven by a rotor F of an adjusting motor G, whose stator H is connected rigidly to a housing J. The housing is connected rigidly to a cylinder head K.

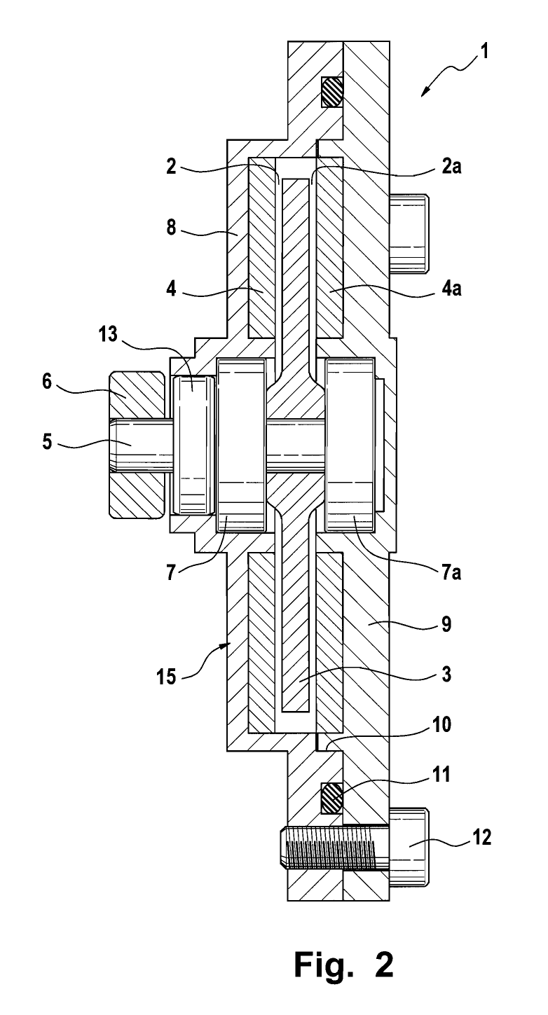

In FIG. 2, a pancake motor 1 provided as a brushless DC motor (BLDC motor) is shown with two air gaps 2, 2a. The air gaps 2, 2a are located between a pancake 3 and a two-part stator 4, 4a. The pancake 3 is locked in rotation with a motor shaft 5 and this is locked in rotation with a coupling element 6. This can be locked in rotation and mounted detachably to an adjusting shaft of an adjusting gear drive (not shown).

The motor shaft 5 is supported in two roller bearings 7, 7a, which in this representation are embodied as deep groove ball bearings, which are arranged on both sides of the pancake 3 directly next to the pancake and in a housing 8 as well as in a cover 9 of the pancake.

The housing 8 and its cover 9 are arranged relative to each other by means of a radial guide 10, mutually sealed by an O-ring 11, and can be held together by screws 12. The motor shaft 5 is sealed by a radial shaft seal ring 13 and the free end of the motor shaft 5 is sealed by the closed cover 9.

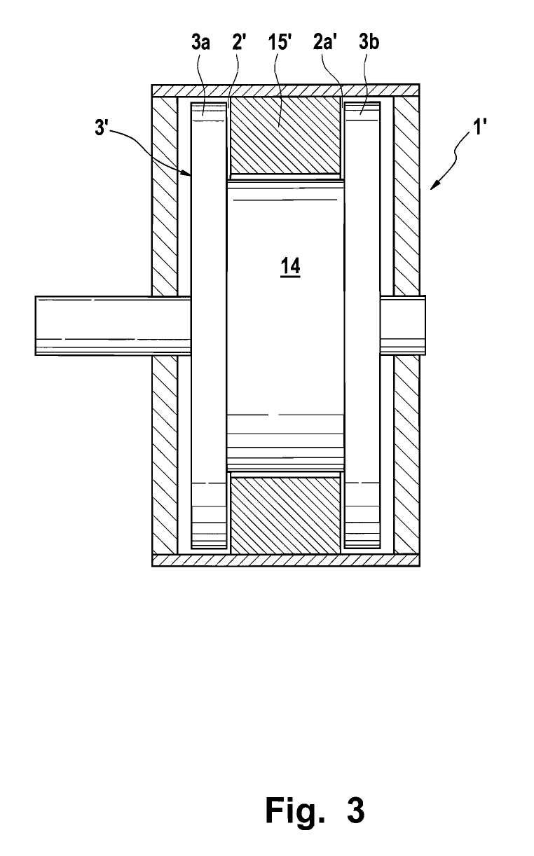

FIG. 3 shows the schematic of a pancake motor 1′ with two air gaps 2′, 2a′, whose pancake 3′ is embodied in two parts. The pancake 3′ is composed of two pancake parts 3a and 3b, which are connected by a hub 14. The stator 15′ is located in the axial direction between the two pancake parts 3a and 3b.

For pancake motors 1, 1′, axial forces are generated between the stator 15, 15′ and the pancake 3, 3′ due to the axially directed magnetic field of the permanent magnet and the energized winding parts 19. For symmetric arrangements of the stator 15′ and pancake 3′ in the pancake motors 1′ with two air gaps, in which a stator 15′ (pancake 3′) lies in the axial direction in front of and behind the pancake 3′ (stator 15′), these forces act in opposite directions and are compensated in this way. Theoretically, the axial force can be completely eliminated, which, however, does not work in practice due to tolerances (different sizes of the two air gaps, slightly different windings of the winding parts).

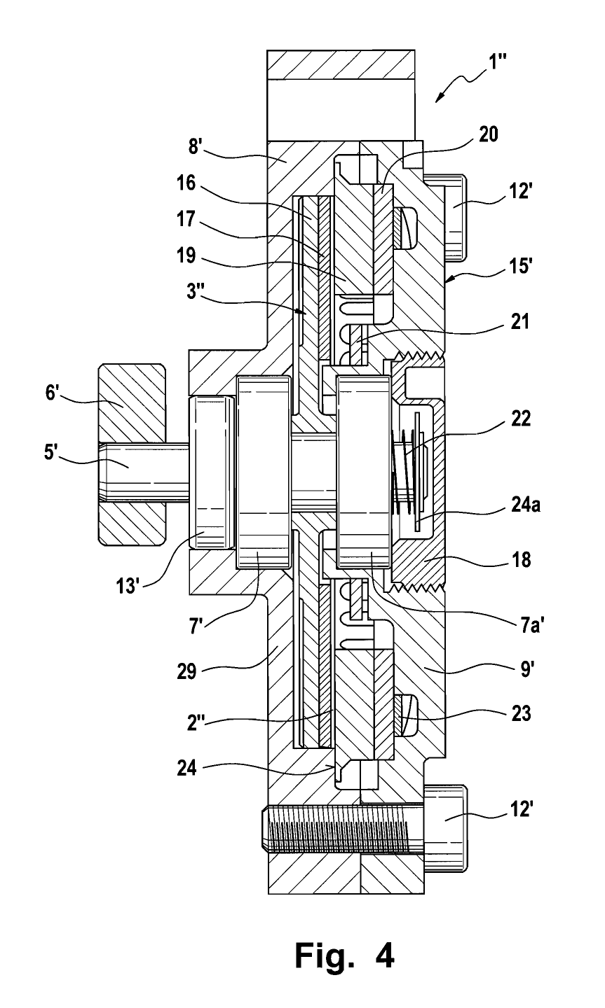

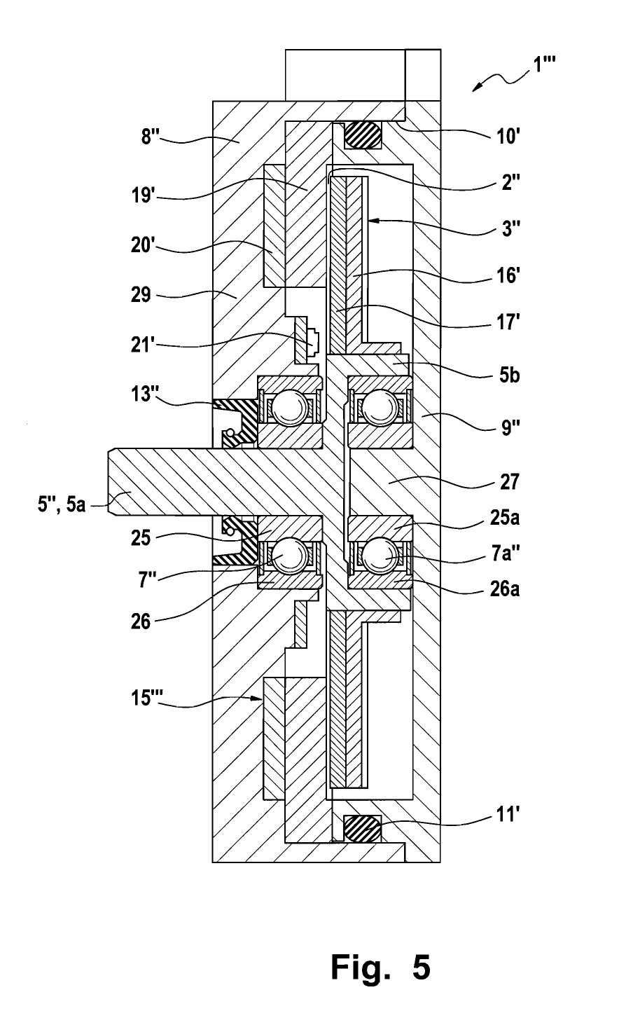

In FIG. 4, a pancake motor 1″ with only one air gap 2″ is shown. This pancake motor 1″ also has a housing 8′, which is closed by a cover 9′ via screws 12′. In the housing 8′ and cover 9′, there are roller bearings 7′, 7a′, which are used for supporting a motor shaft 5′ and are provided in this example as deep groove ball bearings.

The roller bearings 7′, 7a′ are sealed from the outside on the side of the motor shaft 5′ close to the output by a radial shaft seal ring 13′ and on the side away from the output by a closing cover 18 that can be screwed down.

The motor shaft 5′ is locked in rotation with a pancake 3″ and with a coupling element 6′, wherein the pancake 3″ is arranged between the roller bearings 7′, 7a′ and the coupling element 6′ on the end of the motor shaft 5′ close to the output.

The pancake 3″ is composed of a yoke part 16 and a permanent magnet part 17. The latter is arranged opposite a winding part 19 of a stator 15″, on whose rear side there is a stator yoke 20. Within the stator 15″ there are position sensors 21, which are used for controlling the electrical commutation and which are energized by the permanent magnet part 17 of the pancake 3″. The permanent magnet part 17 is composed of several circular sector-like permanent magnets, which are arranged on the disk-shaped yoke part 16, such that in its entirety it produces a circular ring. Consequently, the yoke part 16 is used as a carrier, by means of which the permanent magnets are mounted on the motor shaft 5, 5′, 5″. Furthermore, the yoke part is arranged in the case of a motor with one air gap on the side facing away from the stator 15, 15′, 15″, 15′″ and can be composed of a magnetizable material for recirculation of the magnetic flux. The magnetic polarity of the individual permanent magnets runs in the axial direction of the yoke part 16 and adjacent circular sectors are mounted with alternating polarity.

The permanent magnets fulfill two tasks. First, in connection with the winding parts of the stator/stators 15, 15′, 15″, 15′″ they form the drive for the motor. Second, they deliver the position signal to be detected by the position sensors 21, 21′. Consequently, instead of the circular sector-like configuration of the permanent magnets, a partial ring-shaped configuration can be selected, wherein the permanent magnets extend in the radial direction only in a region, in which either the winding parts of the stator 15, 15′, 15″, 15′″ or the position sensors 21, 21′ are located. In connection with this, an embodiment, in which the permanent magnets are arranged in two concentric circular rings is also conceivable, wherein one circular ring lies in the radial direction in the region of the winding parts and the second circular ring lies in the region of the position sensors 21, 21′.

To maintain the provided width of the air gap 2″, a motor shaft compression spring 22 and a stator compression spring 23 are provided. The motor shaft compression spring 22 is supported on a compression ring 24a connected to the motor shaft 5′ and on the outer ring of the roller bearing 7a′ away from the output and compensates for the bearing play of the roller bearings 7′, 7a′. The stator compression spring 23 is arranged in a ring groove formed in the cover 9′ and presses the stator 15″ against a stator stop 24, whereby the manufacturing and installation play of the stator 15″ is compensated.

During the operation of the pancake motor 1″, the winding parts 19 are energized with high currents, which leads to a large generation of heat at the stator 15″. To prevent heat-specific damage to the winding parts 19 and to the position sensors 21, a sufficient heat transfer from the pancake motor 1″ must be ensured. The pancake motor 1″ is located in the motor space outside of the cylinder head, wherein the housing side 29 of the pancake motor 1″ facing away from the cover 9′ contacts a not-shown cylinder head at least partially directly. In the embodiment shown in FIG. 4 of a pancake motor 1″ according to the invention with one stator 15″ and thus also only one air gap 2″, both the stator 15″ and also the position sensors 21 are mounted on the cover 9′ on the side facing away from the cylinder head within the pancake motor 1″. The cover 9′ projects into the motor space and is cooled therein by the prevailing convection in this space. By mounting the heat-sensitive components directly on the cover or by producing heat-transfer paths to the cover, the components are cooled effectively. To reinforce this effect, cooling ribs are also provided on the cover 9′ and/or air is blown onto the cover by means of a fan-type component. Furthermore, the heat transfer between the position sensors or the winding parts 19 and the cover 9′ is increased through the use of heat-transferring materials, such as, for example, heat-conductive pastes.

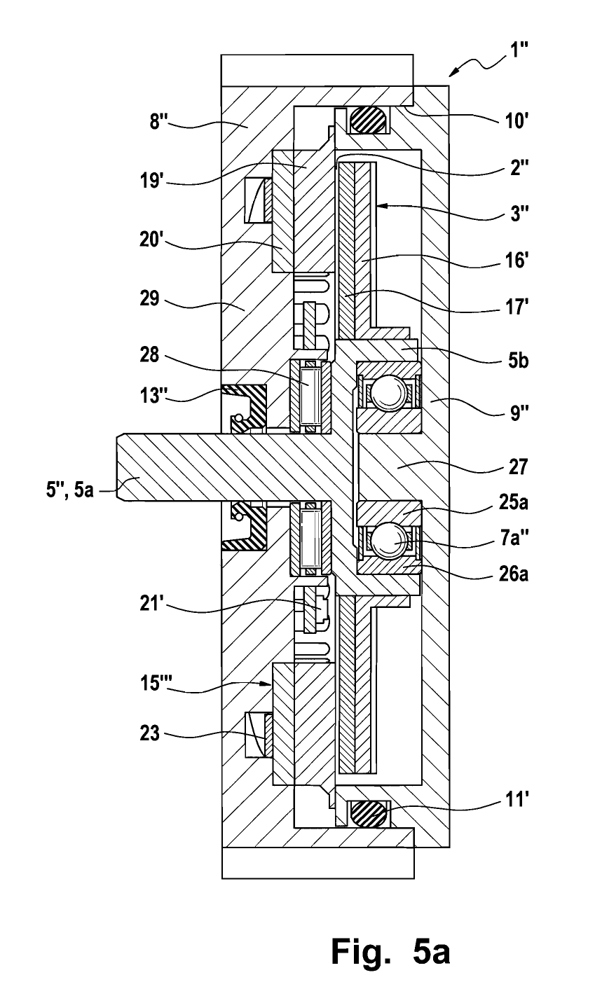

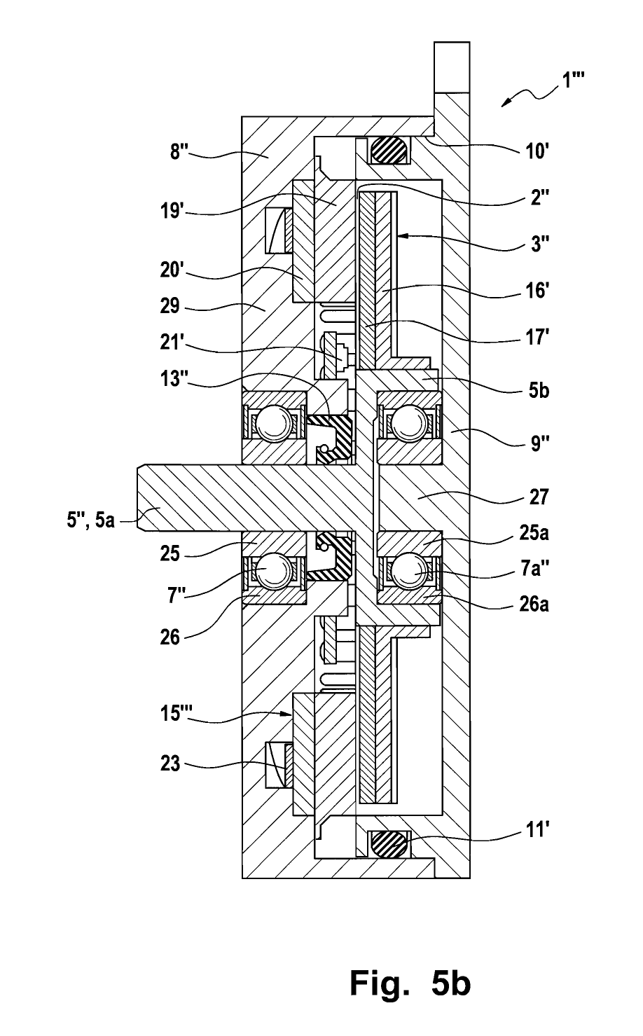

A pancake motor 1′″ of FIG. 5 likewise has only one air gap 2″. The basic construction is similar to that of the pancake motor 1″. The essential difference lies in the shape of the motor shaft 5″, whose solid part 5a is mounted in its inner ring 25 for a roller bearing 7″ close to the output and whose hollow part 5b is mounted on its outer ring 26a for a roller bearing 7a″ away from the output. Therefore, the roller bearing 7a″ away from the output can be pushed partially into the pancake 3″ and closer to the roller bearing 7″ close to the output. In this way, the axial dimensions of the pancake motor 1′″ are minimized.

The roller bearings 7″, 7a″ are sealed internally and provided with long-term lubricant filling.

The pancake motor 1′″ has a housing 8″, which is closed by a cover 9″. The cover 9″ is centered in a radial guide 10′ of the housing 8″ and both are sealed by an O-ring 11. The cover 9″ carries a central peg 27, onto which the inner ring 25a of the roller bearing 7a″ close to the output is pressed.

The pancake 3″ composed of a yoke part 16′ and a permanent magnet part 17′ sits on the hollow part 5b of the motor shaft 5″ with a press fit.

The outer ring 26 of the roller bearing 7″ close to the output is pressed into the housing 8″. Likewise for the radial shaft seal ring 13″, which seals the motor shaft 5″ from outside.

The stator 15′″ with the stator yoke 20′ and the winding part 19′ is also arranged in the housing 8″. Within this housing there are also position sensors 21′ for the electronic commutation. The stator 15′″ is fixed axially by the cover 9″. The pancake motor 1′″ is mounted on a not-shown cylinder head with the housing side 29 opposite the cover 9″. The motor shaft 5″ projects through an opening in the cylinder head and is connected to a not-shown adjusting gear drive of the camshaft adjuster. Through the opening in the cylinder head, the housing side 29 is charged with motor oil, whereby an effective cooling of the housing side 29 is achieved. Through the radial shaft seal 13″, the interior of the pancake motor is protected from the entry of oil. Furthermore, oil is prevented from escaping from the cylinder head into the motor space by a ring-shaped, tight connection around the motor shaft 5″ between the housing side 29 and the cylinder head. Advantageously, in this embodiment, heat-sensitive and heat-producing components of the pancake motor 1′″, such as, for example, the position sensors 21′ or the winding parts 19′, are mounted on the housing side 29, in order to guarantee an effective transport of heat away from these components. As mentioned above, in connection with this the use of heat-conductive materials or the mounting of cooling ribs on the housing side 29 has a positive effect.

FIGS. 5a and 5b show two embodiments analogous to that shown in FIG. 5, which is why, with regard to its description and function, reference should be made to FIG. 5. The pancake motors shown in FIGS. 5a and 5b differ by the arrangement or the type of roller bearing, by means of which the motor shaft is mounted.

In the embodiment from FIG. 5a, the roller bearing 7″ close to the output is replaced by an axial bearing 28, such as, for example, an axial needle bearing or an axial cylindrical roller bearing. The axial bearing 28 receives the axial forces, which appear due to the use of the pancake motor with only one air gap.

In the embodiment from FIG. 5b, the roller bearing 7″ close to the output is sealed flush with the housing side 29 facing the cylinder head. Within the motor 1′″, the radial shaft seal 13″ connects directly to the roller bearing 7″. The advantage of this embodiment lies in the greater distance between the two bearings. Furthermore, the roller bearing 7″ is cooled by sprayed oil from the cylinder head.

In another embodiment, it is also conceivable to eliminate the roller bearing 7″ close to the output. Here, the motor shaft 5″ is mounted on the driven side by a coupling element, by means of which the motor shaft 5″ is in drive connection to an adjusting shaft of a triple-shaft gear drive.

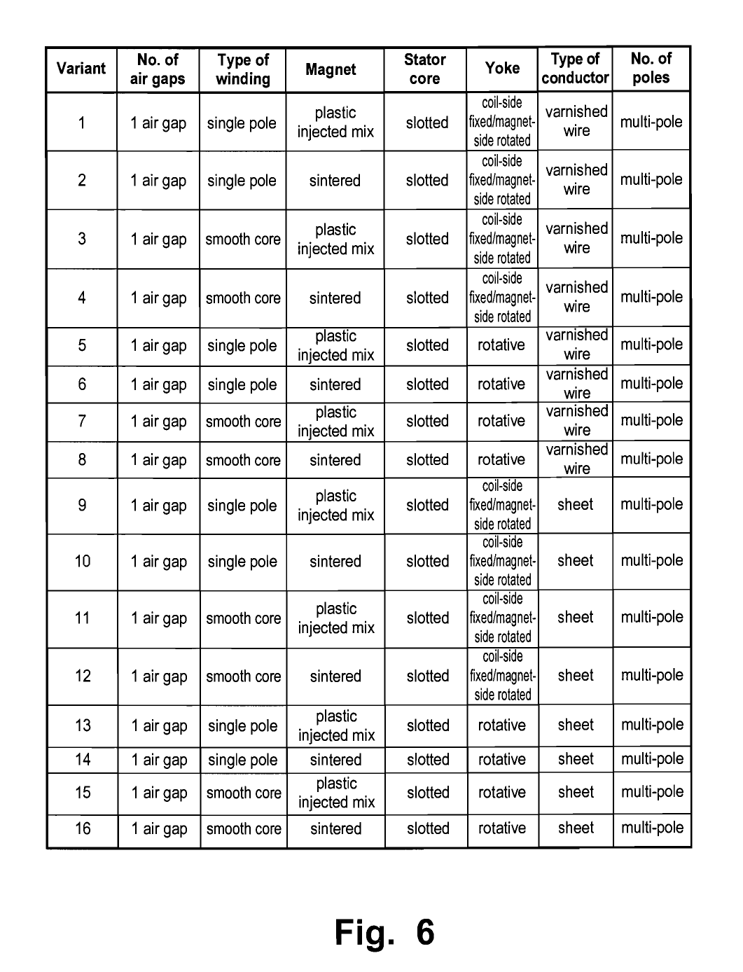

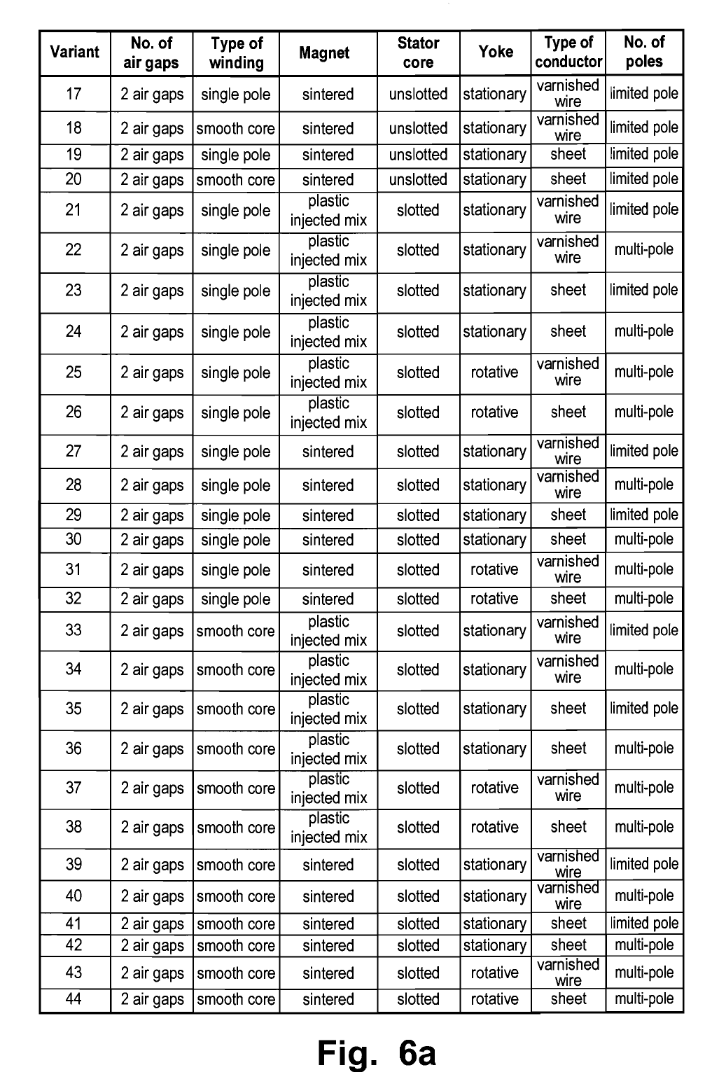

In FIGS. 6 and 6a, tables with variants of pancakes motors are shown, which are suitable for different applications due to their different structural elements.

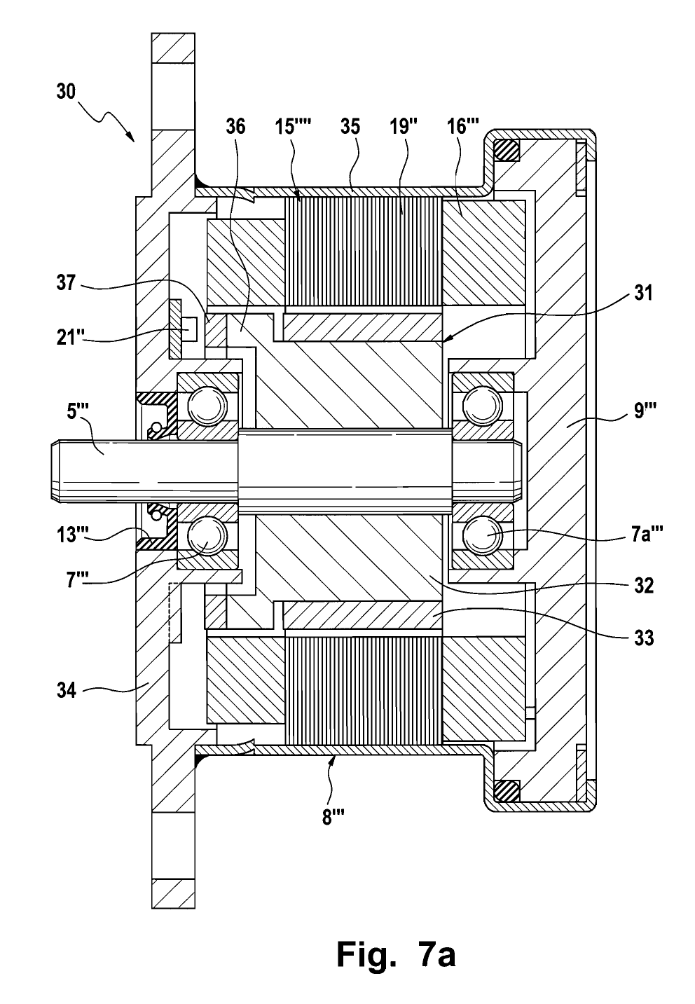

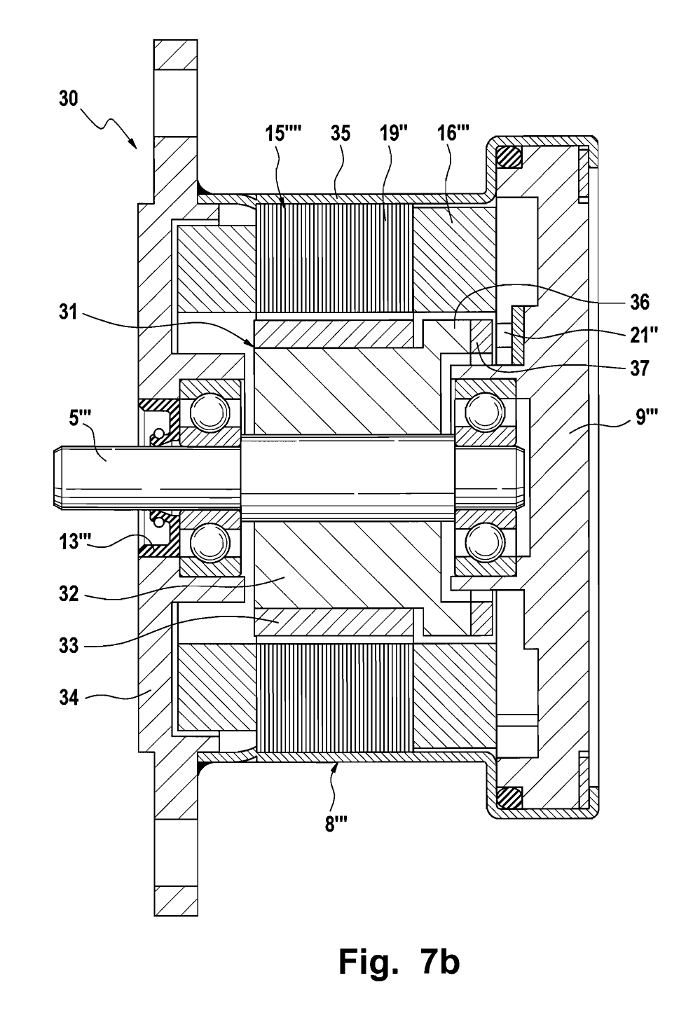

In each of FIGS. 7a and 7b, a cylindrical rotor motor 30 is shown. A rotor 31 embodied as a cylindrical rotor comprises a motor shaft 5′″, on which a cylindrical-shaped yoke 32 is locked in rotation. A cylinder jacket-shaped permanent magnet 33, which surrounds the yoke, is locked in rotation on the outer jacket surface of the yoke 32. The permanent magnet 33 is composed of several partially cylindrical jacket-shaped segments. The magnetic poles of the segments lie along the radial direction and the segments are mounted on the yoke 32, such that the direction of the polarity of adjacent segments alternates.

The rotor 31 and the motor shaft 5″ are mounted in a housing 8′″ by means of a roller bearing close to the output 7′″ and away from the output 7a′″, which are each, in the shown embodiment, a deep groove ball bearing. The housing 8′″ is composed of a flange part 34, a cover 9′″ and a sleeve 35, wherein the flange part 34 and the cover 9′″ are connected in a sealed way to the sleeve 35 with an interference, non-positive, or positive fit. The flange part 34 is provided with bores, with whose help the cylindrical rotor motor 30 can be screwed onto a not-shown cylinder block. A radial shaft seal 13′″ seals the passage of the motor shaft 5′″ through the housing 9′″. The radial shaft seal 13′″ can be mounted between the drive-side roller bearing 7′″ and the cylinder head, or between the drive-side roller bearing 7′″ and the yoke 32.

A stator 15″″ composed of a yoke part 16′″ and winding parts 19″ surrounds the rotor 31 in the peripheral direction. The stator 15″″ is mounted within the housing 8′″ and locked in rotation with this housing.

On the yoke 32 there is an axially extending ring-shaped projection 36, on whose end face a ring-shaped second permanent magnet 37 is mounted, which is opposite housing-fixed position sensors 21″, which are used for controlling the electrical commutation. The second permanent magnet 37 is divided into segments like the first permanent magnet 33 and mounted on the projection 36 such that the segment limits of the two permanent magnets 33 and 36 are localized to identical positions on the side of the periphery.

In the embodiment of the cylindrical rotor motor 30 in FIG. 7a, the position sensors 21″ are mounted on the flange part 34. The flange part 34 directly contacts the cylinder head and is charged with sprayed oil and therefore cooled analogous to the above description with reference to the pancake motor 1′″. The direct contact of the position sensors 21″ on the cooled flange part 34 protects this from overheating and thus lengthens the service life of the cylindrical rotor motor 30.

In the embodiment of the cylindrical rotor motor 30 in FIG. 7b, the position sensors 21″ are mounted on the cover 9′″. The cover 9′″ projects into the motor space and is cooled there by the prevailing convection in this space. The direct contact of the position sensors 21″ on the cooled flange part 34 protects these from overheating and lengthens the service life of the cylindrical rotor motor 30.

The effectiveness of both embodiments can be increased by increasing the cooled surface area, for example, by forming cooling ribs, or better thermal bonding of the position sensors 21″ on the flange part 34 or the cover 9′″.

### REFERENCE SYMBOLS

1, 1′, 1″, 1′″ Pancake motor

2, 2a, 2′, 2″ Air gap

3, 3′, 3″ Pancake

3a, 3b Pancake parts

4, 4a Stator parts

5, 5′, 5″, 5′″ Motor shaft

5a Solid part of the motor shaft

5b Hollow part of the motor shaft

6, 6′ Coupling element

7, 7′, 7″, 7′″ Roller bearing close to output

7a, 7a′, 7a″, 7a′″ Roller bearing away from output

8, 8′, 8″ Housing

9, 9′, 9″, 9′″ Cover

10, 10′ Radial guide

11, 11′ O-ring

12, 12′ Screw

13, 13′, 13″, 13′″ Radial shaft seal

14 Hub

15, 15′, 15″, 15′″, 15″″ Stator

16, 16′, 16″ Yoke part

17, 17′ Permanent magnet part

18 Closing cover

19, 19′ Winding part

20, 20′ Stator yoke

21, 21′, 21″ Position sensor

22 Motor shaft compression spring

23 Stator compression spring

24 Stator stop

24a Compression ring

25, 25a Inner ring

26, 26a Outer ring

27 Central peg

28 Axial bearing

29 Housing side

30 Cylindrical rotor motor

31 Rotor

32 Yoke

33 Permanent magnet

34 Flange part

35 Sleeve

36 Projection

37 Second permanent magnet

A Camshaft adjuster

B Drive wheel

C Adjusting gear drive

D Camshaft

E Motor shaft

F Rotor

G Adjusting motor

H Stator

J Housing 20

K Cylinder head

1. Electrical camshaft adjuster for adjusting and fixing a phase position of a camshaft of an internal combustion engine relative to a crankshaft, wherein the camshaft adjuster includes a triple-shaft gear drive, comprising a crankshaft-fixed drive wheel, a camshaft-fixed driven part, and an adjusting shaft, which is driven by an electric adjusting motor that comprises a pancake motor and that has a pancake and a stator which are arranged in a housing with an associated cover, the pancake motor comprises a brushless DC motor (BLDC motor).

2. Camshaft adjuster according to claim 1, wherein the housing and the cover are fixed to a cylinder head.

3. Camshaft adjuster according to claim 1, wherein the pancake has a motor shaft which is connected to the adjusting shaft by a detachable coupling.

4. Camshaft adjuster according to claim 1, wherein the cover includes a sensor module, which is comprised of plastic and in which a punched lattice is integrated, which is used for conductive connection of a plug injection-molded on the cover with position sensors for electronic commutation, as well as with connections for the stator.

5. Camshaft adjuster according to claim 1, wherein the housing includes a sensor module, which is formed of plastic and in which a punched lattice is integrated, which is used for the conductive connection of a plug injection molded on the housing with position sensors for electronic commutation, as well as with connections for the stator.

6. Camshaft adjuster according to claim 4, wherein the position sensors can be acted upon preferably by the pancake.

7. Camshaft adjuster according to claim 1, wherein the pancake is comprised of a permanent magnet, which is sintered or bonded to plastic and which is mounted on a disk-shaped carrier, by which the pancake is pressed onto the motor shaft.

8. Camshaft adjuster according to claim 1, wherein the stator is slotted or non-slotted.

9. Camshaft adjuster according to claim 5, wherein a stator yoke is provided as a toroidal magnetic-strip wound core and a stator core is formed as a sintered disk with sintered teeth as separate parts which can be joined together, or the stator yoke and the stator core are produced integrally from a wide toroidal magnetic-strip wound core by milling or stamping stator slots from the core.

10. Camshaft adjuster according to claim 1, wherein an end stage of the pancake motor has a bipolar operation.

11. Camshaft adjuster according to claim 1, wherein the pancake is supported on roller bearings and the roller bearings comprise deep groove ball bearings and are arranged in the housing and in the cover.

12. Camshaft adjuster according to claim 11, wherein the motor shaft is mounted with an inner ring of the deep groove ball bearing close to an output and with an outer ring of the deep groove ball bearing away from the output.

13. Camshaft adjuster according to claim 1, wherein an O-ring is provided between the housing and the cover as a seal and a radial shaft seal ring is provided between the motor shaft and housing.

14. Camshaft adjuster according to claim 1, wherein the pancake motor includes one air gap.

15. Camshaft adjuster according to claim 14, wherein a coaxial motor shaft compression spring acting on the motor shaft in a direction of the stator is provided.

16. Camshaft adjuster according to claim 14, wherein a coaxial stator compression spring acting on the stator in a direction of the pancake is provided.

17. Camshaft adjuster according to claim 1, wherein the pancake motor includes two air gaps.

18. Camshaft adjuster according to claim 17, wherein the stator comprises two parts with stator parts or the pancake comprises two parts with the pancake parts and each surrounds a complementary component in the axial direction.

19. Camshaft adjuster according to claim 1, wherein the winding parts of the stator are comprised of stamped sheets, molded parts, or enameled wire.

20. Camshaft adjuster according to claim 1, wherein a number of pole pairs of 2 to 12 is provided.
